(19) United States
(12) Patent Application Publication
(10) Pub. No.: US 2005/0279289 A1
(43) Pub. Date: Dec. 22, 2005

(54) Lariat having dissimilar flexibility and method

(76) Inventor: Roy G. Sattler, Benton, LA (US)

Correspondence Address: John M. Harrison, 2139 E. Bert Kouns, Shreveport, LA, 71105, US

(21) Appl. No.: 11/145,582

(22) Filed: Jun. 6, 2005

Related U.S. Application Data
(60) Provisional application No. 60/580,963, filed on Jun. 21, 2004.

(51) Int. Cl. A01K 15/04

(52) U.S. Cl. 119/805

(57) ABSTRACT

A lariat having dissimilar flexibility to facilitate greater ease and efficiency in “dallying” or snubbing the handling and tail end around the saddlehorn and yet maintain sufficient rigidity and stiffness in the noose or loop to facilitate heading and heeling a steer. In a preferred embodiment a selected length of the “dallying” end extending the tail of the lariat is constructed with greater flexibility than the remainder of the lariat, including the noose or loop, to facilitate this objective. Creating a greater flexibility in the “dallying” end of the lariat facilitates a more efficient and rapid snubbing of the “dallying” end to the saddlehorn, with less chance of injury to the roper's fingers and thumb, than has previously been thought possible. A method of constructing a lariat having dissimilar flexibility in the noose or loop and the handling or tail end to facilitate more efficiency and speed in “dallying” or snubbing the handling end to a saddle horn in a roping operation.

### CROSS-REFERENCE TO RELATED APPLICATIONS

This application claims the benefit of and incorporates by reference prior copending U.S. Provisional Application Ser. No. 60/580,963, filed Jun. 21, 2004.

### DESCRIPTION OF THE PRIOR ART

The development of the “catch rope” or lariat is closely associated with, and was developed for the purpose of handling animals such as horses. Early lariats were constructed of woven horse hide or stranded rawhide and the most primitive riatas are believed to be plaited horse hair. Such “catch ropes”, lariats or “lasso” ropes were used for lassoing or roping steers, horses and other animals and later evolved into the modem hemp rope which is typically constructed of three or four-strand hemp and may contain strands of such materials as nylon and polyester to help control rope stiffness. While the hair ropes were generally light in weight and tended to kink, the modem hemp or composite rope is heavier, better resists kinking and has superior strength and efficiency for roping. Typically, a 35-foot manila rope which is three eighths of an inch in diameter is recommended as a highly efficient lariat for beginners, with a 7/16 inch diameter rope having a length of 30-35 feet normally used by professionals.

In creating the noose or loop element of the lariat, a running knot or honda is typically constructed using a wall knot and wire may be applied to the honda to add sufficient weight for throwing. These ropes are commonly used for heading and heeling a steer and the flexibility and resilience of the ropes are typically constant along the entire length of the rope, from rope to rope, with the rope stiffness determined by the choice of materials in the rope strands, as well as the tightness of the twist applied to the strands in the manufacturing process, depending upon the heeling or heading objective. Typical stiffness grades of rope are hard, medium hard, soft and medium soft and generally, the “heeling” rope is more stiff and less flexible than the “heading” rope.

### SUMMARY OF THE INVENTION

This invention relates to lariats and more particularly, to a lariat having a “dallying” or snubbing and tail end of greater flexibility and resiliency than the remainder of the lariat, including the noose or loop. Using a lariat having more flexibility in the “dallying” or handling end than the noose or loop end allows the roper to “head” or “heel” a steer faster and more safely, where the noose has conventional flexibility. Snubbing or “dallying” a more flexible, pliant tail end of the lariat around a saddlehorn is effected more quickly, efficiently and safely using the lariat of this invention. The invention includes a method of constructing a lariat having dissimilar flexibility along the length thereof, typically including greater flexibility in the tail or snubbing end than the loop or nose end.

### BRIEF DESCRIPTION OF THE DRAWING

The invention will be better understood by reference to the attached drawing wherein:

FIG. 1 is a perspective view of the lariat of dissimilar flexibility of this invention, wherein the noose or loop is illustrated in position around the hind legs of a steer in a “heeling” roping operation;

FIG. 2 is a perspective view of a conventional saddle, illustrated in phantom, with the “dallying” or snubbing and tail end of a conventional lariat having one loop partially deployed around the saddlehorn, illustrating the act of snubbing the “dallying” end to the saddlehorn after a steer is roped;

FIG. 3 is a perspective view of the conventional saddle illustrated in FIG. 2, more particularly illustrating the more pliant and flexible “dallying”, snubbing or tail end of the lariat of dissimilar flexibility of this invention partially snubbed around the saddlehorn in a more efficient initial wrap configuration; and

FIG. 4 is a perspective view of the head and neck of a steer, more particularly illustrating a noose or loop of conventional flexibility tightened thereon in a “heading” roping procedure.

### DESCRIPTION OF THE PREFERRED EMBODIMENTS

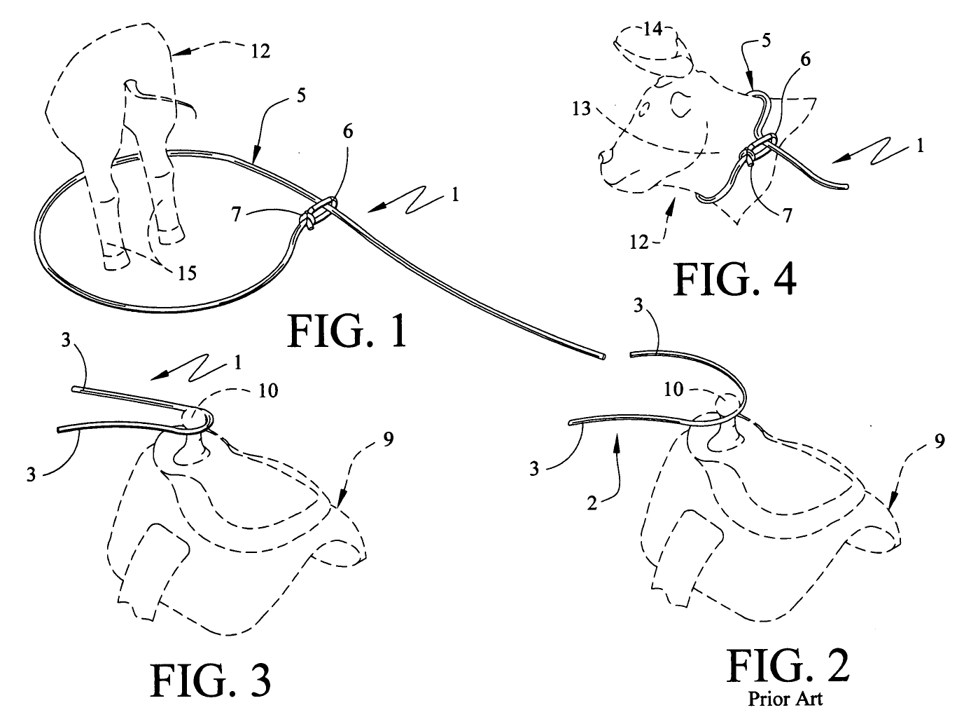

Referring initially to FIGS. 1 and 4 of the drawings, the lariat having dissimilar flexibility of this invention is generally illustrated by reference numeral 1 and includes a noose or loop 5 of conventional selected flexibility, which is adjustable and may be thrown and applied to the hind legs 15 of a steer 12, as illustrated in FIG. 1, or to the head and neck 13 of the steer 12, as illustrated in FIG. 4. As further illustrated in FIG. 4 the noose or loop 5 must clear at least one of the horns 14 in order to tighten around the head and neck 13 of the steer 12 without deduction of rodeo points. This roping the head and neck 13 of the steer 12 with a lasso is known as “heading” the steer, while roping the hind legs 15 as illustrated in FIG. 1, is known as “heeling” the steer.

Referring now to FIG. 2 of the drawings a conventional lariat 2 is illustrated having a snubbing or “dallying” end 3 of conventional selected flexibility which matches the flexibility of the adjustable noose or loop 5 illustrated in FIG. 1. This stiffness and general lack of flexibility in the snubbing or “dallying” end of the conventional lariat 2 necessitates the application of a relatively wide initial loop applied to the saddlehorn 10 of the saddle 9 (illustrated in phantom) and requires significant technique, as well as considerable finger and thumb strength and dexterity, and time, to create the desired number of wraps of the stiff snubbing or “dallying” end 3 of the conventional lariat 2 around the saddlehorn 10 after the steer is roped. This substantial stiffness in the snubbing or “dallying” end 3 of the conventional lariat 2 not only costs the roper time in execution but also presents a danger to the roper's fingers and thumbs (not illustrated), since considerable strength in the hands is necessary to rapidly wrap the stiff snubbing or “dallying” end 3 around the saddlehorn 10, thus requiring a tight grip of the rope in the thumbs and fingers to do so. In the course of such snubbing or “dallying” of the rope, one or more of the fingers or the thumbs are sometimes dangerously caught between the coil or coils of the snubbing or “dallying” end 3 and the saddlehorn 10 as the conventional lariat 2 is tensioned between the steer 12 and the saddlehorn 10, thus resulting in injury to, or even loss of fingers or thumbs in the roping action.

Referring now to FIG. 3 of the drawings under circumstances where the snubbing or “dallying” end 3 of the lariat having dissimilar flexibility 1 of this invention has been constructed with increased flexibility and is more pliable than the conventional lariat 1, the more limp snubbing or “dallying” end 3 is more quickly, efficiently and safely wrapped around the saddlehorn 10, which facilitates a faster and safer snubbing of the snubbing or “dallying” end 3, thus also requiring less strength in the hands, fingers and thumb of the roper. This increased efficiency and minimum strength lariat manipulation requirement allows the roper to more efficiently remove the fingers and thumbs from the danger area between the rope and the saddlehorn during the snubbing maneuver, thus reducing injuries to the hands of the user.

The lariat having dissimilar flexibility 1 of this invention can be constructed by varying the tightness of weave between the noose or loop 5 and the snubbing or “dallying” end 3 and/or by omitting from the snubbing end 3 those strands of materials which lend stiffness to the lariat during construction. Flexibility can also be achieved by subjecting a selected length of the snubbing or “dallying” end 3 of the lariat to steam or water, thus reducing the stiffness therein and facilitating a more limp and flexible rope end for the purpose. Alternatively, materials such as vaseline and paraffin, which are normally used to waterproof lariats, may be applied to the noose or loop 5 and other areas of the rope, but not to the snubbing or “dallying” end, to allow water vapor to penetrate the snubbing or “dallying” end and thus increase the flexibility therein. Other techniques known to those skilled in the art may be applied to the snubbing or “dallying” end 3 of the lariat with dissimilar flexibility 1 illustrated in the drawing to increase the flexibility therein, as desired.

While the preferred embodiments of the invention have been described above, it will be recognized and understood that various modifications may be made in the invention and the appended claims are intended to cover all such modifications which may fall within the spirit and scope of the invention.

1. A lariat having dissimilar flexibility comprising a loop segment characterized by a first selected flexibility and an end segment connected to said loop segment, said end segment characterized by a second selected flexibility, wherein said second selected flexibility in said end segment is greater than said first selected flexibility in said loop segment.

2. The lariat of claim 1 wherein said end segment of said lariat is more limp than said loop segment of said lariat.

3. The lariat of claim 1 wherein said loop segment of said lariat is more stiff than said end segment of said lariat.

4. The lariat of claim 1 wherein:
(a) said end segment of said lariat is more limp than said loop segment of said lariat; and
(b) said loop segment of said lariat is more stiff than said end segment of said lariat.

5. The lariat of claim 1 wherein said end segment of said lariat is twisted less tightly than said loop segment of said lariat.

6. A lariat comprising a rope having dissimilar flexibility along the length thereof.

7. The lariat of claim 6 wherein said rope is configured to define a loop segment having a first selected flexibility, an intermediate segment extending from said loop segment, said intermediate segment having a second selected flexibility and an end segment extending from said intermediate segment, said end segment having a third selected flexibility and wherein said third selected flexibility of said end segment is greater than said first selected flexibility of said loop segment and said second selected flexibility of said intermediate segment of said lariat.

8. The lariat of claim 7 wherein said first selected flexibility in said loop segment is substantially equal to said second selected flexibility in said intermediate segment of said lariat.

9. A method for constructing a lariat having dissimilar flexibility from selected flexible strands of material, comprising the steps of:
(a) twisting a first selected length of said strands in a first selected tension in the lariat; and
(b) twisting a second selected length of said strands in a second selected tension in the lariat, wherein said second selected tension is less than said first selected tension.

10. The method according to claim 9 comprising the step of shaping an adjustable loop in said first selected length of said strands.

11. The method according to claim 9 comprising the step of selecting and twisting said second selected length of said strands wherein said second selected length of said strands is sufficiently long for snubbing around a saddlehorn in a roping operation.

12. The method according to claim 9 comprising the steps of:
(a) shaping an adjustable loop in said first selected length of said strands; and
(b) selecting and twisting said second selected length of said strands wherein said second selected length of said strands is sufficiently long for snubbing around a saddlehorn in a roping operation.

13. The method according to claim 1 wherein said selected strands of material comprise first selected strands provided in a first selected length of said lariat and second selected strands provided in a second selected length of said lariat and wherein said second selected strands are more flexible than said first selected strands.

14. The method according to claim 13 comprising the step of shaping an adjustable loop in said first selected strands of said first selected length of said lariat.
